(19) United States
(12) Patent Application Publication
(10) Pub. No.: US 2026/0287708 A1
(43) Pub. Date: Sep. 24, 2026

(54) RADAR SPECTRUM SHARING

(71) Applicant: Google LLC, MOUNTAIN VIEW, CA (US)

(72) Inventors: Jibing WANG, San Jose, CA (US); Erik STAUFFER, Sunnyvale, CA (US)

(21) Appl. No.: 19/476,382

(22) PCT Filed: Apr. 18, 2024
(86) PCT No.: PCT/US2024/025154

§ 371 Date: Oct. 17, 2025

Related U.S. Application Data
(60) Provisional application No. 63/461,006, filed on Apr. 21, 2023.

(51) Int. Cl. G01S 7/00; H04W 16/14

(52) U.S. Cl. CPC G01S 7/006; H04W 16/14

(57) ABSTRACT

Methods and apparatuses for allocating radio resource(s) for radar sensing are described. A radar device or radio communication device can request one or more radio resources to be used for radar sensing from another radio communication device which otherwise uses those one or more radio resources to provide data communication with other radio devices. The requesting radar device or radio communication device transmits a radar waveform according to the identified one or more radio resources.

### BACKGROUND

A next-generation (NG) mobile network, such as 6G, will likely use communication frequency signal resources for radar sensing. While a 5G waveform can support radar sensing, 6G is expected to use a new waveform for communication-only, sensing-only, or for joint communication and sensing. An orthogonal time frequency space (OTFS) modulation waveform could be used as a 6G waveform.

Sensing can be monostatic or bistatic. In monostatic sensing 100, as illustrated in FIG. 1A, a radar transmitter, e.g., FIG. 3 base station 102 component 334, transmits a radar waveform (sensing signal) having pulses 104 toward a target object 106 and receives the return echoes or reflections 108 of the transmitted signal. In bistatic sensing 103, as illustrated in FIG. 1B, a radar transmitter, e.g., base station 102, transmits a sensing signal having pulses 104 toward a target object 106, and a radar receiver, e.g., another base station 110 (at another location), receives the return echoes or reflections 108 of the transmitted signal. The radar receiver could be a 6G base station or a 6G UE, or a separate mobile radar-specific device or component.

Radar sensing can be used in multiple environments, such as in a manufacturing plant or in fleet/traffic management, to detect, e.g., the position and/or movement of objects. Although radar sensing can be performed on many different frequency bands, some radar sensing signals (e.g., OTFS) may coexist on a frequency or band spectrum that is already being used by other radio communication systems for data/voice communications, e.g., by legacy 4G and/or 5G systems.

Accordingly, embodiments address technical problems associated with shared access to, and use of, one or more radio resources for radar sensing.

### SUMMARY

This disclosure provides techniques for facilitating radar sensing by a radar transmitter utilizing wireless communication air interface resources, e.g., one or more radio resources, allocated to 4G/5G communications.

According to an embodiment, a method for radar sensing, performed by a radar transmitter of a first base station, includes requesting, by the radar transmitter from a second base station, one or more radio resources for radar sensing. The radar transmitter receives an identifier of the requested one or more radio resources. Then the radar transmitter transmits a radar waveform on the identified one or more radio resources.

According to another embodiment, a method for allocating radio resources for radar sensing, performed by a base station that does not support radar sensing, includes receiving, by the base station from a radar transmitter, a request for one or more radio resources for radar sensing. The base station then transmits, to the radar transmitter, an identifier of the one or more requested radio resources.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A and 1B illustrate monostatic and bistatic sensing, respectively;

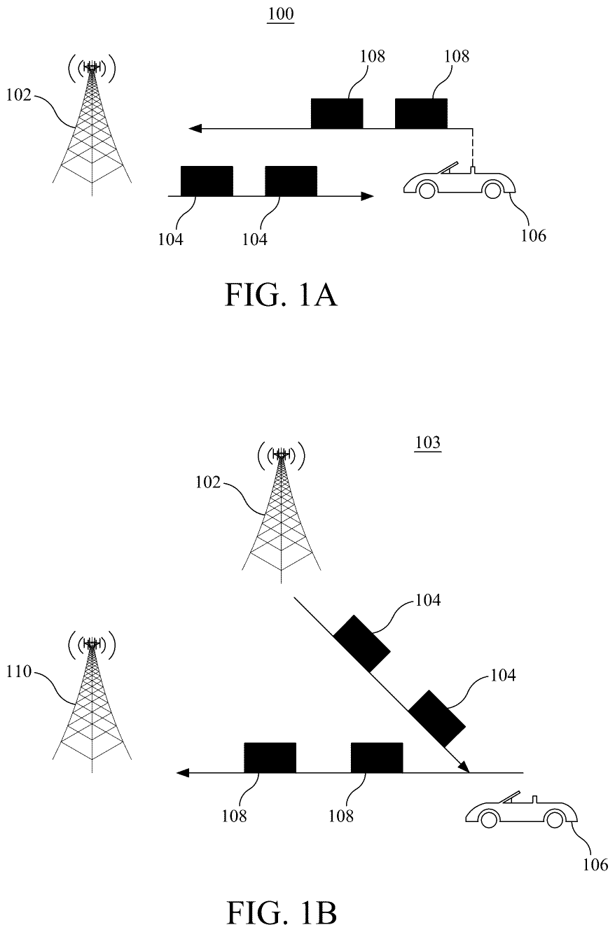

FIG. 2 illustrates a system including two base stations performing bistatic radar sensing and a separate eNodeB (eNB) or gNodeB (gNB), e.g., examples of base stations that might not support radar sensing, in communication with a UE according to embodiments;

FIG. 3 is a block diagram illustrating software and hardware of a UE and a base station according to embodiments;

FIG. 4 shows control and radar signaling between a base station that supports radar transmissions (e.g., an NG-BS), an eNodeB (eNB) or a gNodeB (gNB) (e.g., base stations that might not support radar sensing), and a radar receiver (e.g., an NG base station operating as a radar receiver) with radar transmissions avoiding a specified configuration according to an embodiment;

FIG. 5 shows control and radar signaling between a base station that supports radar transmissions (e.g., an NG-BS), an eNodeB (eNB) (e.g., a base station that might not support radar sensing), and a radar receiver (e.g., an NG base station operating as a radar receiver) where one or more multi-broadcast single-frequency (MBSFN) resources are allocated and used for radar sensing according to an embodiment;

FIG. 6 shows control and radar signaling between a base station that supports radar transmissions (e.g., an NG-BS), a gNodeB (gNB) (e.g., a base station that might not support radar sensing), and a radar receiver (e.g., an NG base station operating as a radar receiver) where one or more downlink synchronization signal block (SSB) resources are allocated and used for radar sensing according to an embodiment;

FIG. 7 shows control and radar signaling between a base station that supports radar transmissions (e.g., an NG-BS), an eNodeB (eNB) or gNodeB (gNB) (e.g., a base station that might not support radar sensing), and a radar receiver (e.g., an NG base station operating as a radar receiver) where one or more radio resources are allocated and used for radar sensing according to an embodiment;

FIG. 8 is a flowchart illustrating a method, performed by a base station that supports communication and radar sensing (e.g., an NG-BS); and

FIG. 9 is a flowchart illustrating a method, performed by a base station that supports at least wireless communication (but not necessarily radar sensing, e.g., an eNB or a gNB), for allocating resources to a base station that supports radar sensing (e.g., NG-BS).

### DETAILED DESCRIPTION

This disclosure describes embodiments for facilitating radar sensing in communication systems by allocating radio communication resources for radar sensing in ways that mitigate interference with communication signaling.

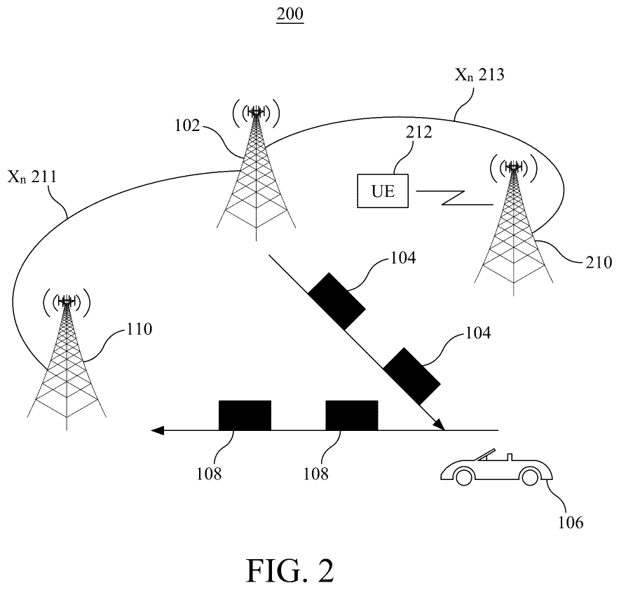

Referring to FIG. 2, a system 200 for bistatic radar sensing, according to an embodiment, includes a radar transmitter, e.g., a first base station 102, a radio communication device, e.g., a second base station 210, which is in radio communication with a user equipment (UE) 212, a radar receiver, e.g., a third base station 110, and an object 106. The radar transmitter 102 and the radar receiver 110 perform radar sensing to detect the position of the object 106.

First and third base stations 102 and 110 are used as specific examples of a radar transmitter and radar receiver, respectively, in this embodiment. However, any devices capable of transmitting radar waveforms and receiving radar waveforms can alternatively be used to implement these functions. If base stations 102 and 110 function as the radar transmitter and radar receiver, respectively, they can operate (for example) in accordance with 5G, NG (6G), or any communication standards which are capable of transmitting and receiving wireless communications and radar waveforms. Alternatively, for example, the radar receiver could be a UE that is capable of receiving a radar waveform.

The second base station 210 exemplifies a portion of a radio communication network delivering communications services to UE 212. The embodiments described herein generally provide techniques to enable radar sensing by other entities without causing radio failure for the second base station 210 communication services. In some cases, it will be desirable to perform radar sensing by transmitting and receiving radar waveforms on frequencies that are already allocated to a radio communication network for delivering the communication services. For example, it might be desirable to use a frequency in the 4.1 GHz-7.125 GHz range (FR1) to perform wide-range radar sensing on object 106 or to use a frequency in the 24.25 GHz-52.6 GHz range (FR2) to perform high-resolution radar sensing on object 106. However, frequencies in these ranges may already be allocated to the second base station 210 for radio communications, e.g., if the second base station 210 is part of a legacy 4G or 5G network.

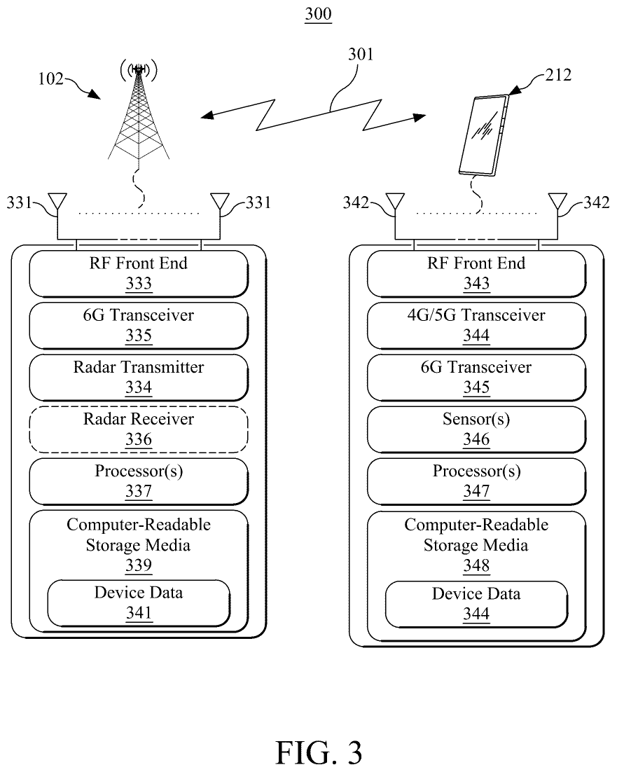

FIG. 3 depicts a wireless communication system 300 including UE 212 and BS 102, that can implement various techniques related to radar sensing according to embodiments. UE 212 and BS 102 may include additional functions and interfaces omitted from FIG. 3 in the interest of brevity. Signaling arrow 301 generally represents both uplink and downlink signals transmitted by UE 212 and BS 102, respectively.

UE 212 includes antennas 342 connected to a radio frequency (RF) front end 343, and at least one RF transceiver (such as, an LTE or 5G transceiver 344, or a 6G transceiver 345) for communicating with NE 102. The antennas 342 and the RF front end 343 can be tuned to one or more frequency bands (e.g., subcarriers), for example, as defined by 3GPP LTE, 5G NR, and 6G communication standards and implemented by respective transceivers. UE 212 also includes one or more sensors 346, e.g., a camera, a gyroscope, an accelerometer, etc., one or more processor(s) 347, and computer-readable storage media (CRM) 348. Processor(s) 347 may be single or multiple-core processors, and CRM 348 includes any suitable memory/storage other than propagating signals. For example, memory/storage can include random-access memory (RAM), static RAM (SRAM), dynamic RAM (DRAM), non-volatile RAM (NVRAM), read-only memory (ROM), and/or flash memory useable to store device data 344. Device data 344 stores instructions executable by processor(s) 347 to facilitate user-plane communication, control-plane signaling, and user interaction for UE 212, including (in some embodiments) radar waveform detection.

BS 102, as illustrated in FIG. 3, provides the functionality of a gNB (5G or 6G base station) or any other base station capable of transmitting a radar waveform. BS 102's functionality may be distributed across multiple entities (e.g., a central unit, CU, a distributed unit, DU, and a radio unit, RU). BS 102 includes antennas 331 and an RF front end 333, a radar transmitter 334, and a 6G RF transceiver 335 (there may be more transceivers for different technologies, as illustrated for UE 212) for communicating with UE 212 and other BSs. BS's antennas 331 and RF front end 333 can be tuned to one or more frequency bands (e.g., subcarriers), for example as defined by 3GPP LTE, 5G NR, and 6G communication standards and implemented by RF transceiver(s) 335.

BS 102 also includes processor(s) 337 and computer-readable storage media (CRM) 339. Processor(s) 337 can include single or multiple-core processors, and CRM 339 includes any suitable memory/storage except propagating signals. For example, memory/storage can include random-access memory (RAM), static RAM (SRAM), dynamic RAM (DRAM), non-volatile RAM (NVRAM), read-only memory (ROM), and/or flash memory. CRM 339 stores device data 341, which includes network scheduling data, radio resource management data, applications, and/or an operating system, which are executable by processor(s) 423 to enable wireless communication 301 with UE 212 as well as with other NEs. NE 102 also includes inter-base station interfaces 211 and 213. These inter-base station interfaces can be a standardized interface, such as an Xn and/or X2 interface, for exchanging user-plane and control-plane data with another NE (e.g., in case of a handover).

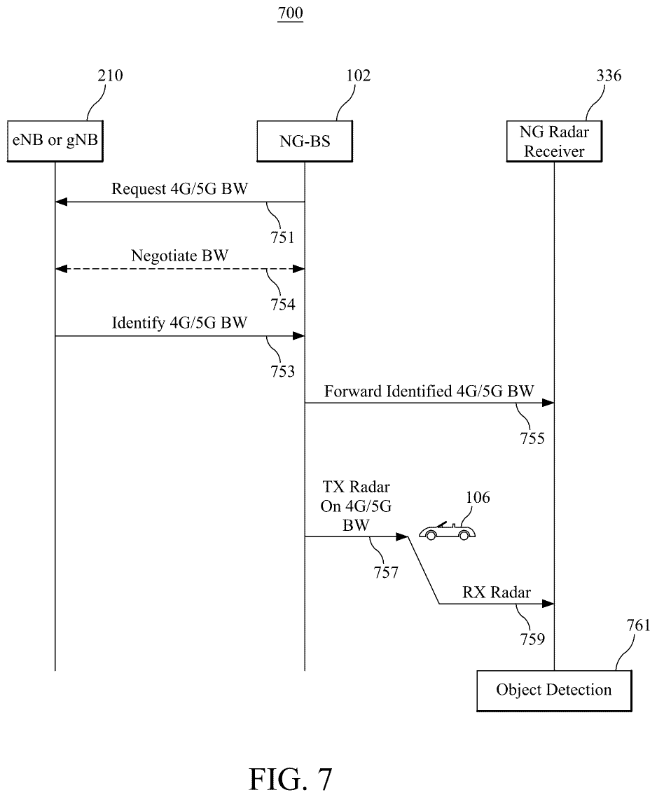

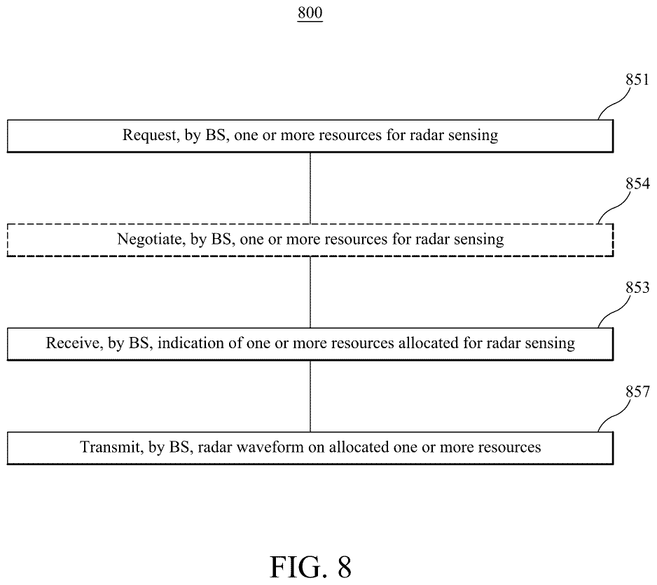

To enable the desired radar sensing to be performed by the radar transmitter and radar receiver, e.g., base stations 102 and 110, without causing radio communication failure, an allocation of one or more radio resources can be made from the second base station 210 to the radar transmitter, e.g., base station 102. In the example of FIG. 2, where the radar transmitter is a first base station 102, the second base station 210 can transmit an identifier of the one or more radio resources to be used for radar sensing to the first base station 102, e.g., via an Xn interface 213. Note that as used herein, the phrase “identifier of the one or more radio resources” is intended to broadly encompass any mechanism for a base station to identify radio resources to a radar transmitter that can be used for radar sensing by the radar transmitter. In some embodiments, the identifier can positively identify one or more radio resources that the radar transmitter can use to transmit a radar waveform. In other embodiments, the identifier can negatively identify one or more radio resources that the radar transmitter cannot or should not use to transmit a radar waveform. In still other embodiments, a base station can inform the radar transmitter more generally regarding how it is configured to use its various radio resources for communications via the transmitted identifier, and the radar transmitter can use a ruleset to determine which of the one or more radio resources to use for the radar waveform. The more generalized embodiments are illustrated in FIGS. 7 and 8 and are described first.

The radio resource(s) used for radar sensing can be one or more 4G/5G radio resources allocatable by base station 210. For example, as shown in FIG. 7, the radar transmitter requests (751) an identification of one or more 4G/5G radio resources for radar sensing. For example, this identification may indicate that the device which transmits the radar waveform either: avoid certain Time-Space-Frequencies, use a specified Time but not specify Space or Frequency, use a specified Time-Space but not specify a Frequency, use a specified Time-Frequency but not specify a Space, or use a specified Time-Space-Frequency. The radio resources can, for example, specify a certain bandwidth to be used for radar sensing, e.g., by communicating a center frequency and a bandwidth around that center frequency (e.g., 100 MHz) that are available for radar sensing.

The radar transmitter, e.g., base station 102, after (optionally) negotiating (754) for the bandwidth, receives (753) an identification of the one or more 4G/5G radio resources. Note that in this context the term “negotiation” or variants thereof refer to one or more pairs of request signals and response signals between the two entities. In some embodiments, the radar transmitter forwards (755) the identified one or more 4G/5G radio resources to the radar receiver 102, 110, 212 so that it can tune to the radar waveform. The radar transmitter transmits (757) the radar waveform toward the object on the identified bandwidth. A waveform reflected off the object is received (759) by the radar receiver and used to detect (761) the object.

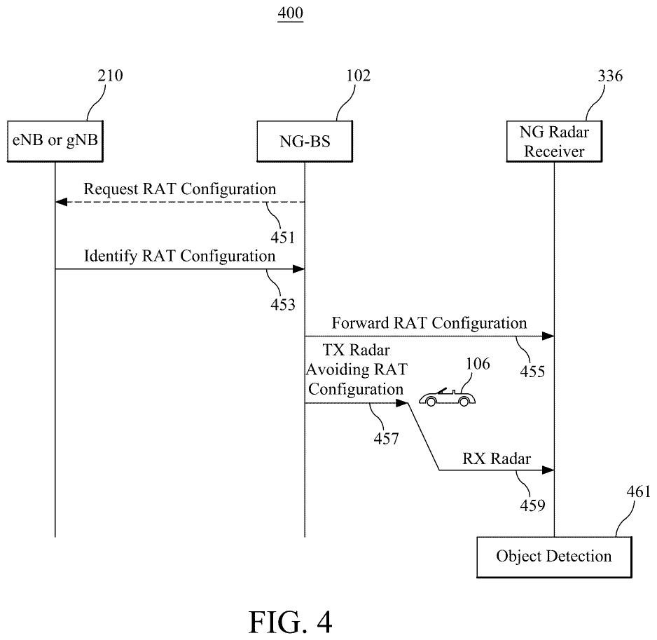

The embodiments described herein can also be expressed as a method flowchart. For example, as illustrated in FIG. 8, a base station 102 with a radar transmitter component 334, requests (851) and, optionally, negotiates (854) for resources for radar sensing from a nearby base station 210. The base station 102 receives (853) from base station 210 an identifier of one or more radio resources allocated for radar sensing. The radar transmitter 334 of base station 102 transmits (857) a radar waveform on the one or more allocated 4G/5G radio resources. Various examples of radio resources that can be allocated for radar sensing are described below with respect to FIGS. 4-7.

Note that FIG. 8 provides an optional negotiation step 854 (i.e., the transmission of one or more requests and responses) for the base station 210 and the radar transmitter 102 to interact as part of the allocation of the one or more radio resources to be used for radar sensing. Regardless of the type(s) of radio resources being allocated for radar sensing in the embodiments described below with respect to FIGS. 4-7, these devices can negotiate the resource allocation, or not, for all embodiments, i.e., the device granting the allocation can make a unilateral grant, or the devices can perform a negotiation. FIGS. 4-7 provide some examples; however, these embodiments are only a few of the ways that the base station 210 can inform the radar transmitter to avoid certain Time-Space-Frequencies, use a specified Time but not specify Space or Frequency, use a specified Time-Space but not specify a Frequency, use a specified Time-Frequency but not specify a Space, or use a specified Time-Space-Frequency.

FIG. 4 depicts an embodiment that is an example of how the base station 210 can inform the radar transmitter 102 regarding its configuration to use its own radio communication resources for communications with UEs, e.g., UE 212. The base station 210 uses a transmitted identifier to indicate its radio access technology (RAT) configuration, and the radar transmitter 102 can then use its own ruleset or otherwise determine which of the one or more radio resources to use to transmit the radar waveform while avoiding at least a portion of the indicated RAT configuration.

Initially, the radar transmitter, e.g., base station 102, optionally requests (451) a radio access technology (RAT) configuration of the base station 210, e.g., in order to know which radio resources the base station 210 uses for various functions. For example, the RAT configuration information could identify one or more radio resources that base station 210 uses, such as: 4G or 5G PDCCH resources being used by the 4G/5G base station, 4G or 5G PUCCH resources being used by the 4G/5G base station, 4G or 5G uplink PRACH resources, cell-specific reference signal (CRS) resources being used by a 4G base station, downlink synchronization signal block (SSB) resources used by a 5G base station, and primary synchronization signal (PSS)/secondary synchronization signal (SSS)/ physical broadcast channel (PBCH) resources being used by the 4G base station, multi-broadcast single-frequency (MBSFN) resources being used by the 4G base station, or the almost-blank subframes (ABS) resources being used by the 4G base station.

The radar transmitter 102 receives (453) the identified RAT configuration from base station 210. The radar transmitter 102 can use this information to identify one or more radio resources on which it will not transmit the radar waveform and instead select another one or more radio resources to transmit the radar waveform. For example, the radar transmitter might opt not to use the one or more radio resources used by base station 210 to transmit (or receive) on one or more of: 4G & 5G PDCCH, 4G cell-specific reference signal (CRS), 5G DL SSB (and its 4G equivalent of SSS/PSS/PBCH), 4G & 5G PUCCH, and 4G & 5G (UL) PRACH.

The RAT configuration can be forwarded (455) by base station 102 to the radar receiver 336. Alternatively, the base station 102 can instead specifically inform the radar receiver 336 regarding which one or more radio resources it will use to transmit the radar waveform. The radar receiver 336 uses this information to perform the required signal processing (such as correlation, spectrum analysis, etc.) for object detection. Without such information, the radar receiver may pick up more interference (from a radar perspective) which may lead to degraded detection performance.

The base station's radar transmitter 334 transmits (457) a radar waveform, avoiding certain RAT configuration resources, toward object 106. A waveform reflected (459) from the object is used by the NG radar receiver 336 to detect the object (461) in either a monostatic or bistatic manner.

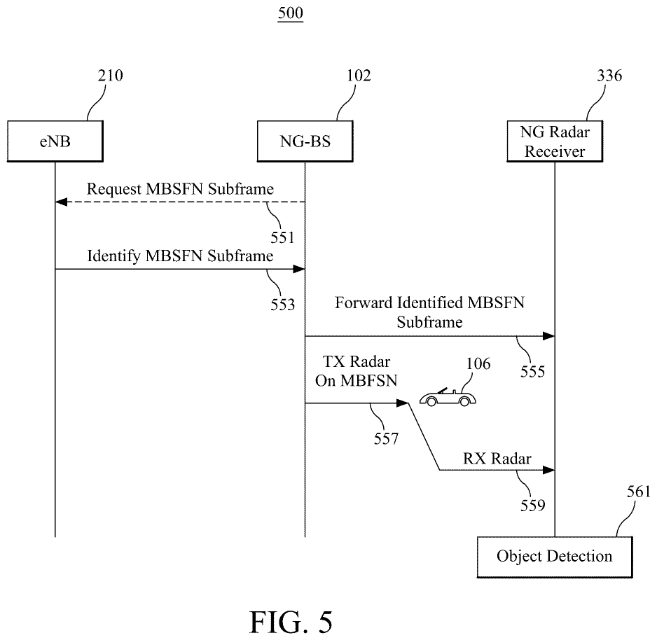

In the previous embodiment, base station 210 identified one or more radio resources that it requested the radar transmitter 102 to avoid. As mentioned above, in other embodiments, base station 210 can proactively make one or more of its allocated radio resources available for radar sensing. One type of radio resource that can be used for this purpose is a multicast-broadcast single-frequency network (MBSFN) subframe. Although typically used for multicast video, base station 210 can instead reserve one or more MBSFN subframes for radar sensing. Thus, as shown in FIG. 5, radar transmitter 102 optionally requests (551) a multicast-broadcast single frequency network (MNSFN) subframe from the base station. The radar transmitter, e.g., base station 102, receives (553) the identity of an MBSFN subframe from the 4G base station. The base station 102, forwards (555) an identifier of the MBSFN subframe to the radar receiver. The base station 102 transmits (557) a radar waveform on radio resources of the identified MBSFN subframe toward the object 106. The radar receiver 336 receives a waveform reflected off the object 106. The radar receiver detects (561) the object 106 based on the reflected waveform, the transmitted waveform, the location of the radar transmitter, and the location of the radar receiver.

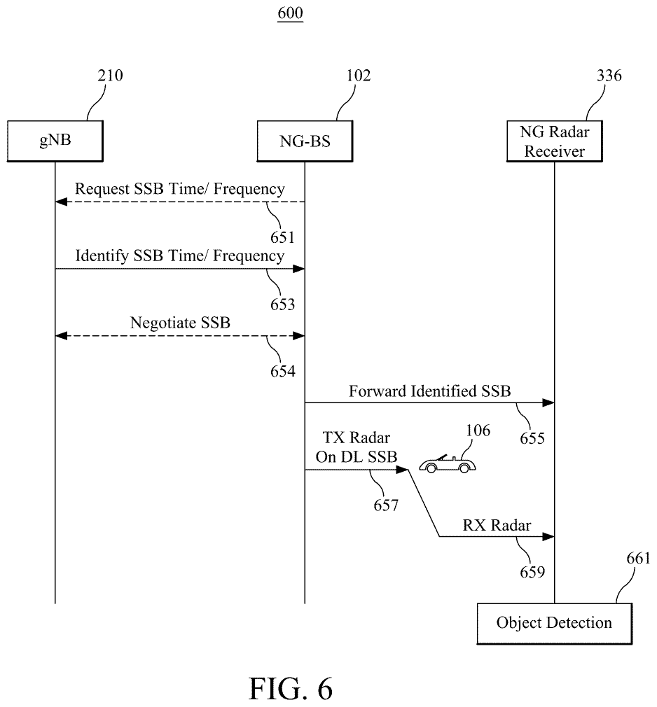

Other radio resources can be proactively allocated by base station 210 for radar sensing or identified for avoidance of radar sensing signals. For example, in a further embodiment shown in FIG. 6, the base station 102 optionally requests (651) identification of synchronization signal block (SSB) time and frequency resources that should not be used for radar sensing or, alternatively, SSB time and frequency resources that can be used for radar sensing if the base station 210 pauses transmission of SSBs on those SSB resources for a period of time to allow base station 102 to use those resources for radar sensing. Base station 102 receives (653) the identification of SSB time and frequency resources after, optionally, negotiating (654) for the identification. Base station 102 forwards (655) an indication of the identified SSB resources to the radar receiver 336 or, alternatively, radio resource(s) which will be used for radar sensing that do not include the identified SSB resources. The base station transmits (657) the radar waveform on the identified SSB time and frequency resources toward the object 106. Radar receiver 336 receives (659) a waveform reflected off the object 106 iand uses the reflection to detect (661) the object 106.

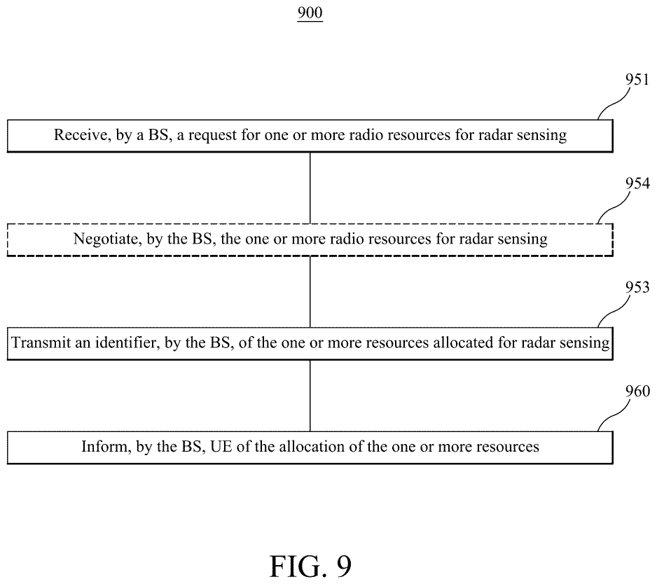

The foregoing embodiments are from the point of view of the radar transmitter 334 acquiring (or being allocated) one or more radio resources on which to transmit a radar waveform to perform radar sensing. Other embodiments are described from the point of view of the communication network, e.g., base station 210. For example, from the point of view of base station 210, as shown in FIG. 9, base station 210 receives (951) a request for radar sensing resources from base station 102 containing a radar transmitter 334. After (optionally) negotiating (954) for the radio resources, base station 210 transmits (953) an indication of resources allocated for radar sensing (or to be avoided for radar sensing) to the base station 102. The base station 210 may inform (960) UEs associated with the base station 210, e.g., UE 212, of the allocation, e.g., to avoid interference/signaling failure if the UEs are otherwise permitted to unilaterally use the one or more resources being allocated for radar sensing.

The foregoing description of the embodiments refers to the accompanying drawings. The same reference numbers in different drawings identify the same or similar elements. The detailed description does not limit the invention. Instead, the scope of the invention is defined by the appended claims. The embodiments discussed are not limited to the configurations described above but may be extended to other arrangements.

Reference throughout the specification to “one embodiment” or “an embodiment” means that a particular feature, structure, or characteristic described in connection with an embodiment is included in at least one embodiment of the present invention. Thus, the appearances of the phrases “in one embodiment” or “in an embodiment” in various places throughout the specification are not necessarily all referring to the same embodiment. Further, the particular features, structures, or characteristics may be combined in any suitable manner in one or more embodiments.

Note that numerical adjectives “first”, “second”, and “third” do not imply any order (are not ordinals) but are markers to distinguish separate instances of similar elements.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

In concluding, it is noted that references to the singular (e.g., “a” or “an”, “the”) should include the plural unless clearly indicated otherwise.

1-15. (canceled)

16. A method for radar sensing performed by a first base station, the method comprising:
requesting, by the first base station from a second base station, to identify a configuration of communication resources used by the second base station;
receiving, by the first base station from the second base station, an identifier of the configuration; and
transmitting, by the first base station, a radar waveform on communication resources different from the communication resources indicated by the identifier of the configuration.

17. The method of claim 16, wherein a first radio access technology, RAT, used by the first base station is different from a second RAT used by the second base station.

18. The method of claim 16, further comprising:
forwarding, by the first base station, the configuration to a radar receiver that receives a reflection of the transmitted radar waveform.

19. The method of claim 18, wherein the radar receiver is one of: a third base station, a user equipment, UE, or a mobile radar-specific device.

20. The method of claim 17, wherein the configuration specifies one or more of:
physical downlink control channel, PDCCH, resources,
physical uplink control channel, PUCCH, resources,
physical random access channel, PRACH, resources,
cell-specific reference signal, CRS, resources,
synchronization signal block, SSB, resources,
primary synchronization signal, PSS, resources,
secondary synchronization signal, SSS, resources,
physical broadcast channel, PBCH, resources,
multi-broadcast single-frequency network, MBSFN, resources, or
almost-blank subframes, ABS, resources,
the one or more PDCCH, PUCCH, PRACH, CRS, SSB, PSS, SSS, PBCH, MBSFN or ABS resources being used or scheduled to be used by the second base station.

21. The method of claim 16, wherein:
the requesting comprises requesting, by the first base station, an identity of a multicast-broadcast single frequency network, MBSFN, subframe usable for radar sensing;
the receiving comprises receiving, by the first base station, the identity of the MBSFN subframe; and
the transmitting comprises transmitting, by the first base station, the radar waveform on radio resources of the MBSFN subframe.

22. The method of claim 16, wherein:
the requesting comprises requesting, by the first base station, an identifier of synchronization signal block, SSB, time and frequency resources usable for the radar sensing;
the receiving comprises receiving, by the first base station, the identifier of SSB time and frequency resources usable for the radar sensing; and
the transmitting comprises transmitting, by the first base station, the radar waveform on the identified SSB time and frequency resources.

23. The method of claim 22, further comprising:
negotiating, by the first base station with the second base station, to turn off downlink SSB associated with the identified SSB time and frequency resources.

24. The method of claim 16, wherein:
the requesting comprises requesting, by the first base station, an indication of one or more communication resources available for radar sensing;
the receiving comprises receiving, by the first base station, the indication of the one or more communication resources; and
the transmitting comprises transmitting, by the first base station, the radar waveform using the indicated one or more communication resources.

25. The method of claim 24, wherein the indication specifies a bandwidth.

26. The method of claim 24, further comprising:
negotiating, by the first base station with the second base station, for the one or more communication resources based on at least one of a latency or priority information.

27. The method of claim 16, wherein the first base station is a next generation, NG, base station.

28. The method of claim 16, wherein the radar waveform includes an orthogonal time frequency space modulation, OTFS, waveform. Page 7

29. The method of claim 16, wherein the communication resources used for the transmitting of the radar waveform differ from the communication resources indicated by the identifier at least one of time, frequency or space.

30. A base station apparatus for radar sensing comprising a first base station, the apparatus comprising:
at least one wireless transceiver; and
a processor coupled to the at least one wireless transceiver and configured to:
request from a second base station to identify a configuration of communication resources used by the second base station,
receive from the second base station an identifier of the configuration, and
transmit a radar waveform on communication resources different from the communication resources indicated by the identifier of the configuration.

31. The base station apparatus of claim 30, wherein the processor is further configured to use a first radio access technology, RAT, that is different from a second RAT used by the second base station.

32. The base station apparatus of claim 30, wherein the processor is further configured to forward the configuration to a radar receiver that receives a reflection of the transmitted radar waveform.

33. The base station apparatus of claim 32, wherein the radar receiver is one of: a third base station, a user equipment, UE, or a mobile radar-specific device.

34. The base station apparatus of claim 30, wherein the configuration specifies one or more of:
physical downlink control channel, PDCCH, resources,
physical uplink control channel, PUCCH, resources,
physical random access channel, PRACH, resources,
cell-specific reference signal, CRS, resources,
synchronization signal block, SSB, resources,
primary synchronization signal, PSS, resources,
secondary synchronization signal, SSS, resources,
physical broadcast channel, PBCH, resources,
multi-broadcast single-frequency network, MBSFN, resources, or
almost-blank subframes, ABS, resources,
the one or more PDCCH, PUCCH, PRACH, CRS, SSB, PSS, SSS, PBCH, MBSFN or ABS resources being used or scheduled to be used by the second base station.

35. The base station apparatus of claim 30, wherein the processor is further configured to:
request an identity of a multicast-broadcast single frequency network, MBSFN, subframe usable for radar sensing, and
receive the identity of the MBSFN subframe; and
transmit the radar waveform on radio resources of the MBSFN subframe.
